(19) United States
(12) Patent Application Publication
(10) Pub. No.: US 2006/0170703 A1
(43) Pub. Date: Aug. 3, 2006

(54) Color compression using an edge data bitmask in a multi-sample anti-aliasing scheme

(75) Inventor: Qunfeng Fred Liao, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/047,904

(22) Filed: Feb. 1, 2005

(51) Int. Cl. G09G 5/00

(52) U.S. Cl. 345/613

(57) ABSTRACT

Systems and methods are provided for compressing computer graphics color data in a system utilizing a multi-sample anti-aliasing scheme using an edge data bitmask to generate a compression code for determining the compressibility of tile color data, where the edge data bitmask is a record of edge locations relative to the pixels and sub-pixels within a tile.

### TECHNICAL FIELD

The present invention generally relates to graphics systems, and more particularly, to color compression using a shared bitmask in a multi-sample anti-aliasing scheme.

### BACKGROUND

As is known, the art and science of three-dimensional (“3-D”) computer graphics concerns the generation, or rendering of two-dimensional (“2-D”) images of 3-D objects for display or presentation onto a display device or monitor, such as a Cathode Ray Tube (CRT) or a Liquid Crystal Display (LCD). The object may be a simple geometry primitive such as a point, a line segment, a triangle, or a polygon. More complex objects can be rendered onto a display device by representing the objects with a series of connected planar polygons, such as, for example, by representing the objects as a series of connected planar triangles. All geometry primitives may eventually be described in terms of one vertex or a set of vertices, for example, coordinate (x, y, z) that defines a point, for example, the endpoint of a line segment, or a corner of a polygon.

To generate a data set for display as a 2-D projection representative of a 3-D primitive onto a computer monitor or other display device, the vertices of the primitive are processed through a series of operations, or processing stages in a graphics-rendering pipeline. A generic pipeline is merely a series of cascading processing units, or stages, wherein the output from a prior stage serves as the input for a subsequent stage. In the context of a graphics processor, these stages include, for example, per-vertex operations, primitive assembly operations, pixel operations, texture assembly operations, rasterization operations, and fragment operations.

In a typical graphics display system, an image database (e.g., a command list) may store a description of the objects in the scene. The objects are described with a number of small polygons, which cover the surface of the object in the same manner that a number of small tiles can cover a wall or other surface. Each polygon is described as a list of vertex coordinates (X, Y, Z in “Model” coordinates) and some specification of material surface properties (i.e., color, texture, shininess, etc.), as well as possibly the normal vectors to the surface at each vertex. For three-dimensional objects with complex curved surfaces, the polygons in general must be triangles or quadrilaterals, and the latter can always be decomposed into pairs of triangles.

A transformation engine transforms the object coordinates in response to the angle of viewing selected by a user from user input. In addition, the user may specify the field of view, the size of the image to be produced, and the back end of the viewing volume so as to include or eliminate background as desired.

Once this viewing area has been selected, clipping logic eliminates the polygons (i.e., triangles) which are outside the viewing area and “clips” the polygons, which are partly inside and partly outside the viewing area. These clipped polygons will correspond to the portion of the polygon inside the viewing area with new edge(s) corresponding to the edge(s) of the viewing area. The polygon vertices are then transmitted to the next stage in coordinates corresponding to the viewing screen (in X, Y coordinates) with an associated depth for each vertex (the Z coordinate). In a typical system, the lighting model is next applied taking into account the light sources. The polygons with their color values are then transmitted to a rasterizer.

For each polygon, the rasterizer determines which pixel positions are covered by the polygon and attempts to write the associated color values and depth (Z value) into a frame buffer. The rasterizer compares the depth values (Z) for the polygon being processed with the depth value of a pixel, which may already be written into the frame buffer. If the depth value of the new polygon pixel is smaller, indicating that it is in front of the polygon already written into the frame buffer, then its value will replace the value in the frame buffer because the new polygon will obscure the polygon previously processed and written into the frame buffer. This process is repeated until all of the polygons have been rasterized. At that point, a video controller displays the contents of a frame buffer on a display one scan line at a time in raster order.

The default methods of performing real-time rendering typically display polygons as pixels located either inside or outside the polygon. The resulting edges which, define the polygon, can appear with a jagged look in a static display and a crawling look in an animated display. The underlying problem producing this effect is called aliasing and the methods applied to reduce or eliminate the problem are called anti-aliasing techniques.

Screen-based anti-aliasing methods do not require knowledge of the objects being rendered because they use only the pipeline output samples. One typical anti-aliasing method utilizes a line anti-aliasing technique called Multi-Sample Anti-Aliasing (MSAA), which takes more than one sample per pixel in a single pass. The number of samples or sub-pixels taken for each pixel is called the sampling rate and, axiomatically, as the sampling rate increases, the associated memory traffic also increases.

With this general background provided, reference is now made to FIG. 1, which shows a functional flow diagram of certain components within a graphics pipeline in a computer graphics system. It will be appreciated that components within graphics pipelines may vary from system to system, and may also be illustrated in a variety of ways. As is known, a host computer 10 (or a graphics API running on a host computer) may generate a command list 12, which comprises a series of graphics commands and data for rendering an “environment” on a graphics display. Components within the graphics pipeline may operate on the data and commands within the command list 12 to render a screen in a graphics display.

In this regard, a parser 14 may retrieve data from the command list 12 and “parse” through the data to interpret commands and pass data defining graphics primitives along (or into) the graphics pipeline. In this regard, graphic primitives may be defined by location data (e.g., x, y, z, and w coordinates) as well as lighting and texture information. All of this information, for each primitive, may be retrieved by the parser 14 from the command list 12, and passed to a vertex shader 16. As is known, the vertex shader 16 may perform various transformations on the graphics data received from the command list. In this regard, the data may be transformed from World coordinates into Model View coordinates, then into Projection coordinates, and ultimately into Screen coordinates. The functional processing performed by the vertex shader 16 is known and need not be described further herein. Thereafter, the graphics data may be passed onto rasterizer 18.

Thereafter, a Z-test 20 is performed on each pixel within the primitive. As is known, this Z-test is performed by comparing a current Z-value (i.e., a Z-value for a given pixel of the current primitive) in comparison with a stored Z-value for the corresponding pixel location. The stored Z-value provides the depth value for a previously rendered primitive for a given pixel location. If the current Z-value indicates a depth that is closer to the viewer's eye than the stored Z-value, then the current Z-value will replace the stored Z-value and the current graphic information (i.e., color) will replace the color information in the corresponding frame buffer pixel location (as determined by the pixel shader 22). If the current Z-value is not closer to the current viewpoint than the stored Z-value, then neither the frame buffer nor Z-buffer contents need to be replaced, as a previously rendered pixel will be deemed to be in front of the current pixel.

Again, for pixels within primitives that are rendered and determined to be closer to the viewpoint than previously-stored pixels, information relating to the primitive is passed on to the pixel shader 22, which determines color information for each of the pixels within the primitive that are determined to be closer to the current viewpoint. Once color information is computed by the pixel shader 22, the information is stored within the frame buffer 24.

Although the foregoing has only briefly summarized the operation of the various processing components, persons skilled in the art will recognize that the processing on graphics data is quite intense. Consequently, it is desired to improve processing efficiency wherever possible.

### SUMMARY

Embodiments of the present disclosure provide a system for compressing color data in a computer graphics system, comprising: a graphics processing unit (GPU); a frame buffer, in communication with the GPU, adapted to maintain color data for a pixel; a plurality of sub-pixels, such that each of the plurality of sub-pixels comprises a color sample for the pixel; a sampling rate, wherein the sampling rate comprises the number of sub-pixels per pixel and wherein the sampling rate is predetermined; a tile, wherein the tile comprises a plurality of pixels; and a tile record, wherein the tile record comprises tile compression data.

Briefly described, one embodiment of the system, among others, can be implemented as computer graphics hardware, comprising a means for generating a compression code for color data using a shared bitmask containing location data for primitive edges relative to sub-pixel locations.

Embodiments of the present disclosure can also be viewed as providing methods of compressing color data in a computer graphics system, comprising the steps of: storing pixel color data in a frame buffer; allocating a plurality of color data samples to each pixel, wherein each of the plurality of color data samples comprises a sub-pixel, such that each pixel comprises a plurality of sub-pixels; generating a tile, such that the tile comprises a plurality of pixels; accessing a tile record, such that the tile record comprises edge data indicating whether the tile is covered by an edge, such that an edge is a boundary between primitives; and determining, using the edge data, how many of the plurality of color data samples is read from the frame buffer.

Embodiments of the present disclosure can also be viewed as providing a computer graphics system comprising: multi-sample anti-aliasing logic configured to store a plurality of color samples for each pixel, wherein each color sample comprises a sub-pixel, such that the color data for each pixel comprises a plurality of sub-pixels, and wherein a tile comprises a plurality of pixels; and color data compression logic configured to provide a compression code for each tile, wherein the compression code comprises a compression type value and a configurable data field, such that the type of data in the configurable data field depends on the tile compression type value.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The accompanying drawings incorporated in and forming a part of the specification illustrate several aspects of the present disclosure, and together with the description serve to explain the principles of the disclosure. In the drawings:

FIG. 1 is a block diagram of a conventional graphics pipeline, as is known in the prior art.

FIG. 2 is a block diagram illustrating a graphics pipeline having elements that are constructed in accordance with an embodiment of the disclosure.

FIG. 3 is a block diagram illustrating certain elements of a graphics component constructed in accordance with an embodiment of the disclosure.

FIG. 4 is a block diagram illustrating an exemplary embodiment of a tile of pixels and pixel color data in a multi-sample anti-aliasing scheme.

FIG. 5 is a block diagram of an embodiment of sub-pixel data in an exemplary tile in an embodiment of the systems and methods herein.

FIG. 6 is a block diagram illustrating an exemplary MSAA pixel in an embodiment of the systems and methods herein.

FIG. 7 is a block diagram illustrating an alternative exemplary MSAA pixel in an embodiment of the systems and methods herein.

FIGS. 8A-8D are simplified illustrations of a fully covered tile utilized in an embodiment of the systems and methods herein.

FIGS. 9A and 9B are simplified diagrams, which illustrate a partially covered tile having one partially covered pixel as utilized in embodiments of the systems and methods herein.

FIGS. 10A and 10B are simplified diagrams, which illustrate a partially covered tile having two partially covered pixels as utilized in embodiments of the systems and methods herein.

FIGS. 11A and 11B are simplified diagrams, which illustrate a partially covered tile having more than two partially covered pixels as utilized in embodiments of the systems and methods herein.

FIG. 12 is a block diagram illustrating an exemplary partial tile record format of an embodiment of the systems and methods herein.

FIG. 13 is a table illustrating an exemplary configuration for an eight-bit compression code, as disclosed herein.

FIG. 14 is a block diagram illustrating a method of compressing color data in an embodiment disclosed herein.

FIG. 15 is a block diagram illustrating a process of performing a method of compressing color data in an embodiment disclosed herein.

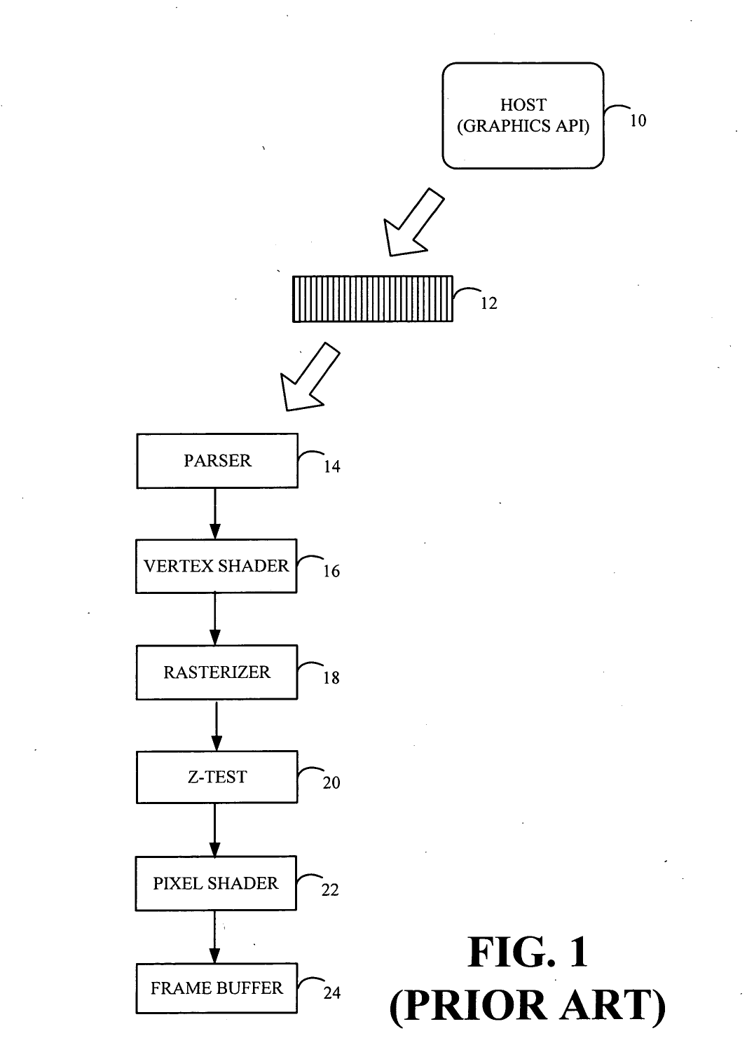

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed therein. On the contrary, the intent is to cover all alternatives, modifications and equivalents included within the spirit and scope of the disclosure as defined by the appended claims.

As will be described further herein, there are several locations in a graphics system where features or aspects of the disclosure may be implemented. Likewise, it will be appreciated from the description herein that there are systems and environments in fields other than computer graphics where the concepts of the disclosure may be employed as well.

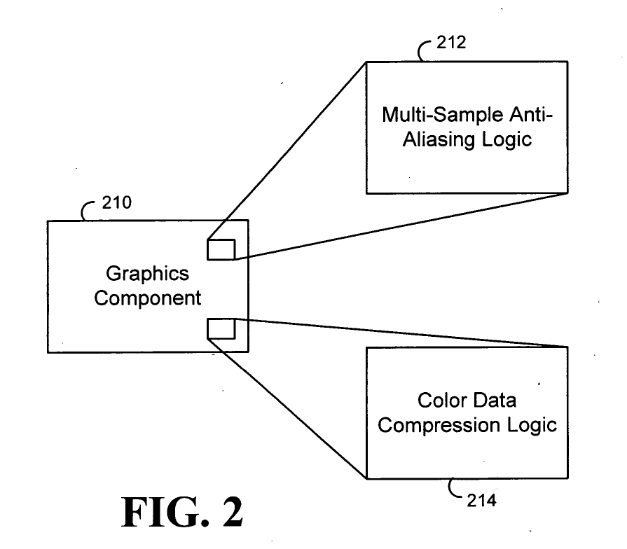

Reference is made briefly to FIG. 2, which illustrates certain basic components of an embodiment of the disclosure. FIG. 2 includes a component labeled “Graphics Component” 210, which may designate or represent hardware components in a graphics pipeline. Within this component, logic 212 may be provided for multi-sample anti-aliasing wherein multiple color samples are stored for each pixel within the frame buffer. Likewise, compression logic 214 may be provided for compressing the color data to reduce the traffic between the processor and the frame buffer. An embodiment of the disclosure may be implemented in systems that provide programmable processing for certain functions, referred to as GPU (Graphic Processing Units), such as the pixel shading, rather than using dedicated hardware for performing this function. In such a system, the reduction of data transmitted between the GPU and the frame buffer using the process described herein greatly improves the efficiency of the programmable GPU processor.

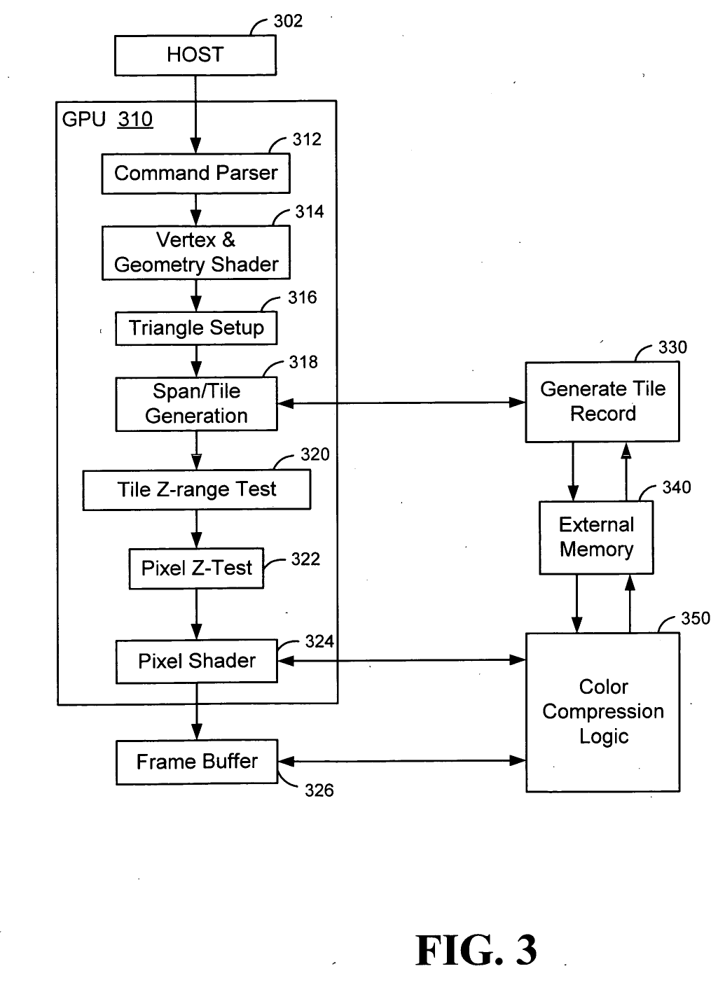

FIG. 3 illustrates certain of these components in one embodiment of a graphics pipeline implementing color data compression functions. More specifically, FIG. 3 illustrates an embodiment of the present disclosure in which a graphics pipeline, employing many conventional components, embodies certain inventive features. For example, within the GPU 310, the command parser 312, vertex and geometry shader 314, triangle setup 316, and the span/tile generation 318 is well-known operations, and need not be described herein. Also known is a tile Z-range test 320, in which a Z-test is performed on compressed Z-data. Compressed Z-tests performed in this way may improve efficiency by trivially accepting or trivially rejecting certain primitives (or alternatively, ranges of pixels) based upon compressed Z-information. A similar, per-pixel, test may be performed by the pixel Z-test block 322.

The graphics pipeline of FIG. 3 also illustrates logic for generating a tile record 330 in external memory 340, a pixel shader 324 and logic for performing a color data compression 350. The pixel shader 324 and the tile record generation 330 blocks perform functions that are known in the art, and need not be described herein. As the name implies, the pixel shader 324 performs shading operations on a per-pixel basis. For a given graphic primitive that is being operated upon, or for a given tile in tile-based operations, often a number of the pixels will ultimately not be visible to a user (based on depth information, obstruction by other objects between the current pixel and the view point, etc.). For all such pixels, the pixel shading operation needs not be performed. In a MSAA scheme, the data traffic requirement is greatly increased due to the number of color samples that must be stored for each pixel. Once color information is computed by the pixel shader 324, the information is stored within the frame buffer 326.

The color compression logic 350 reads the tile record from the external memory 340 to perform the compression of the color data in conjunction with the pixel shader 324 to reduce the amount of color data transferred between the GPU 310 and-the frame buffer 326.

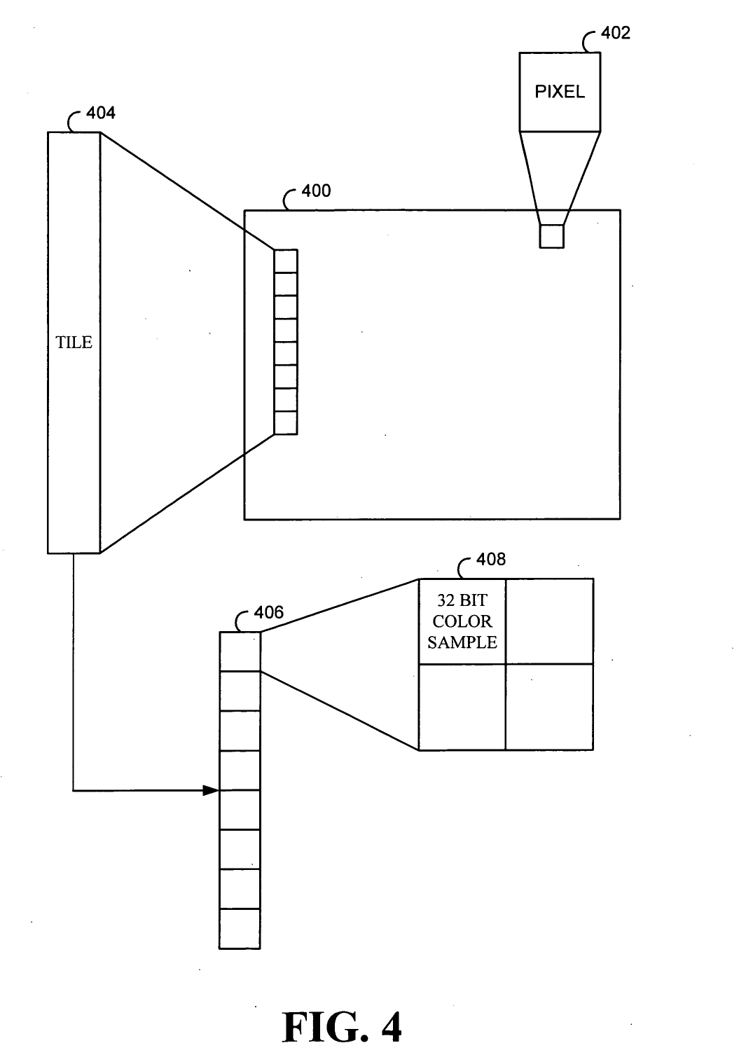

Reference is made briefly to FIG. 4, which illustrates an exemplary graphical data organizational scheme of an embodiment of the present disclosure. Shown first, within the boundaries of a display 400, is one of many pixels 402, the fundamental graphical elements of a graphical display. The pixels 402 are organized into dimensionally specific groups known as tiles 404. The tile of an exemplary embodiment contains eight total pixels in an eight vertical pixel by one horizontal pixel configuration 406. One of ordinary skill in the art knows or will know that tiles of different dimensions are consistent with the systems and methods taught herein.

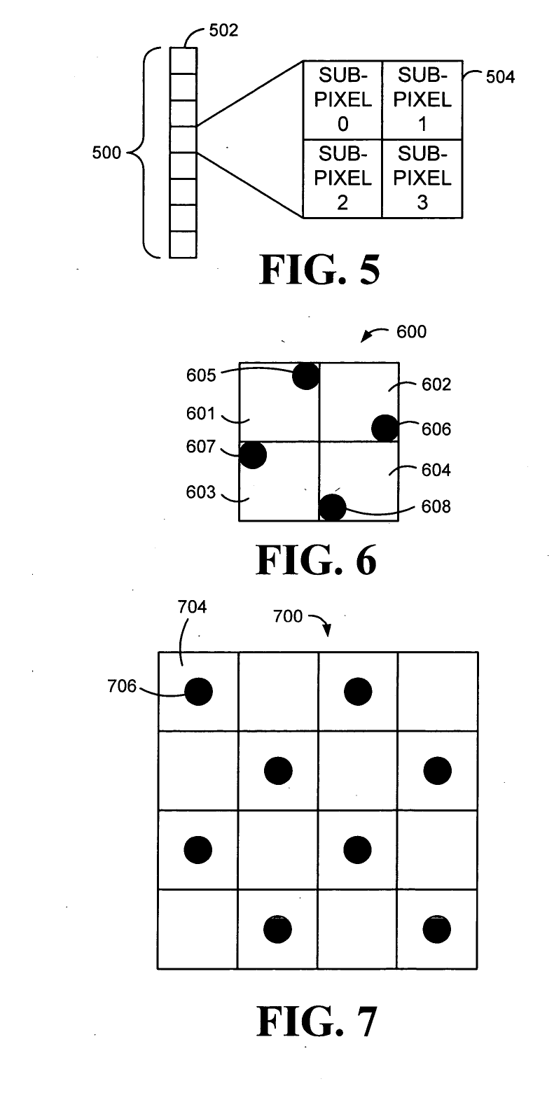

As discussed above, in a computer graphics system, there may be a significant amount of graphics data associated with each pixel 402. This graphics data may include color information, such as red, green, blue, and alpha (R,G,B,A), depth information (Z), texture information (U and V coordinates), etc. Within the context of the MSAA methods, the color information alone may represent a significant amount of data, especially as sampling rates increase. For example, a computer graphics system utilizing MSAA methods with a sampling rate of four would store four different color samples for each pixel. Thus, the color sample data associated with the tile 406 will have four samples of color data 408 for each pixel. Each sample of color data 408 of this embodiment comprises, for example, 32-bits of color data. As discussed below, in reference to FIG. 5, each color sample may also be configured as a sub-pixel. In the case where all color samples for this tile are read from the frame buffer, the total amount of color data is four samples per pixel for eight pixels or 1024 bits.

Reference is now made to FIG. 5, which illustrates a block diagram of an embodiment of sub-pixel data in an exemplary tile. Consistent with the above example, a tile 500 consisting of eight pixels 502 is shown in an exemplary eight vertical pixel by one horizontal pixel configuration. The color data for each pixel 502 is further defined in multiple sub-pixels 504, which each contain a color sample for the pixel. This exemplary configuration features four sub-pixels per pixel as determined by a sampling rate of four. For example, in a system with a sampling rate of sixteen, the color data for each pixel would be defined by sixteen sub-pixels or color samples.

Reference is now made to FIG. 6, which illustrates a block diagram of an exemplary MSAA pixel under the methods herein. The pixel 600 contains four sub-pixels 601-604 of color data, consistent with a sampling rate of four. The sub-pixels 601-604 contain color data samples 605-608, respectively. Note that the color data samples 605-608 are configured to represent the color at different and specific points within the pixel 600. For example, depending on the number and configuration of sub-pixels, the locations of the color data samples 605-608 may be different within each sub-pixel such that the pixel is represented by the color data samples in a thorough and effective manner.

Reference is briefly made to FIG. 7, a block diagram of an embodiment of an exemplary MSAA pixel under the systems and methods herein. The pixel 700 contains eight sub-pixels 704 of color data, consistent with a sampling rate of eight. The sub-pixels 704 contain color data samples 706. Note that the color data samples 706 are configured to represent the color at different and specific points within the pixel 700. Also, note that the eight color data samples 706 provide significantly greater potential for increased color resolution than the four-color data samples 605-608 of the FIG. 6.

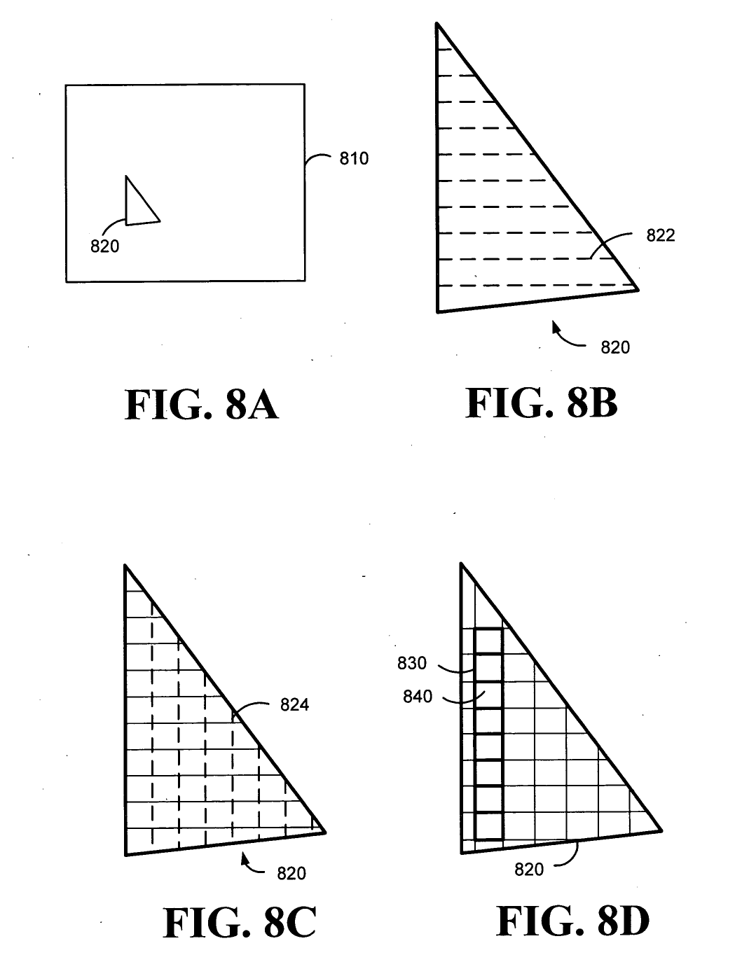

Reference is now made to FIGS. 8A-8D, which illustrate a fully covered tile that may be utilized in embodiments of the present disclosure. It should be appreciated that the illustration of FIGS. 8A-8D is significantly simplified to facilitate the illustration of certain aspects of embodiments of the disclosure. However, the simplified illustration provided herein is sufficient for persons skilled in the art to implement more complex and realistic examples.

Referring first to FIG. 8A, a triangle primitive 820 is shown within the boundaries of a display 810. As is well known, a computer graphics display will often render hundreds or thousands of primitives in a single graphics display. Primitives are frequently broken down to triangle primitives, such as triangle 820. As is known, early (front-end) components in a graphics pipeline perform certain setup and vertex-based operations on the primitives. Span and tiled generation components will break a primitive up into scan lines 822 (FIG. 8B) and pixels 840 (FIG. 8D) defined by vertical lines 824 (FIG. 8C) crossing the scan lines 822. Pixels 840 are often grouped into tiles of 2×2, 4×4, 8×8, or other sized dimensions. FIG. 8D illustrates a tile 830 having a dimension of 1×8 pixels. The alignment of tile 830 is arbitrarily illustrated with reference to the triangle primitive 820. The location of the tile 830 relative to the triangle primitive 820 represents the best case for compression because the tile 830 is fully covered by the triangle primitive 820. The color data read from the frame buffer for the fully covered tile is only the color data for one of the sub-pixels in the tile, realizing a savings over reading the color data for all 32 sub-pixels in the tile.

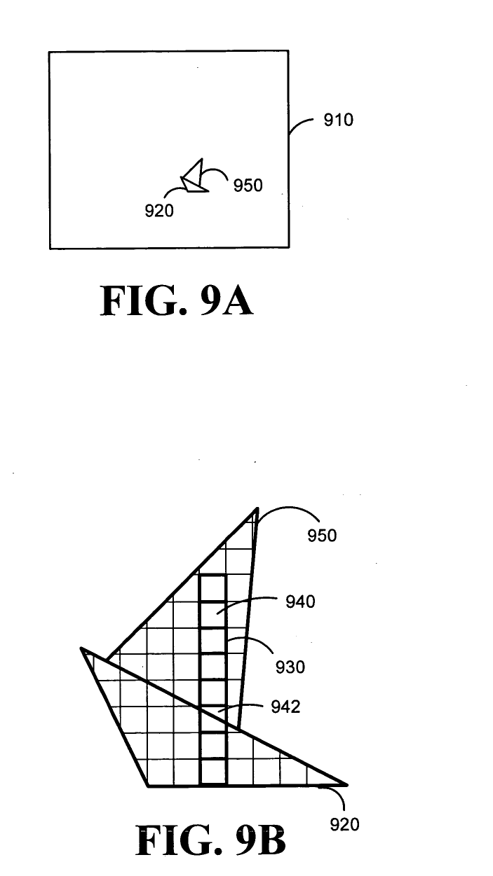

Reference is now made to FIGS. 9A-9B, which illustrate a partially covered tile that may be utilized in embodiments of the present disclosure. It should be appreciated that the illustration of FIGS. 9A-9B is significantly simplified to facilitate the illustration of certain aspects of embodiments of the disclosure. However, the simplified illustration provided herein is sufficient for persons skilled in the art to implement more complex and realistic examples.

Referring first to FIG. 9A, adjacent triangle primitives 920 and 950 are shown within the boundaries of a display 910. As is well known, a computer graphics display will often render hundreds or thousands of primitives, which are frequently broken down to triangle primitives, such as triangles 920 and 950. As discussed in reference to FIG. 8, span and tiled generation components will break a primitive up into pixels 940 (shown in FIG. 9B) defined by vertical lines crossing scan lines. Pixels 940 are often grouped into tiles of 2×2, 4×4, 8×8, or other sized dimensions. FIG. 9B illustrates a tile 930 having a dimension of 1×8 pixels. The alignment of tile 930 is arbitrarily illustrated with reference to the triangle primitives 920 and 950. Unlike the case of a fully covered tile as illustrated in FIG. 8, the tile 930, as shown in FIG. 9B is partially covered by the primitive 920 and partially covered by the primitive 950. Since the tile 930 has only one partially covered pixel 942, optimized color compression in this case will require reading the color data of all sub-pixels in the partially covered pixel 942. Although the savings in memory is less than realized in the fully covered tile, the savings in memory traffic still justifies performing the color compression, especially as the sampling rate increases.

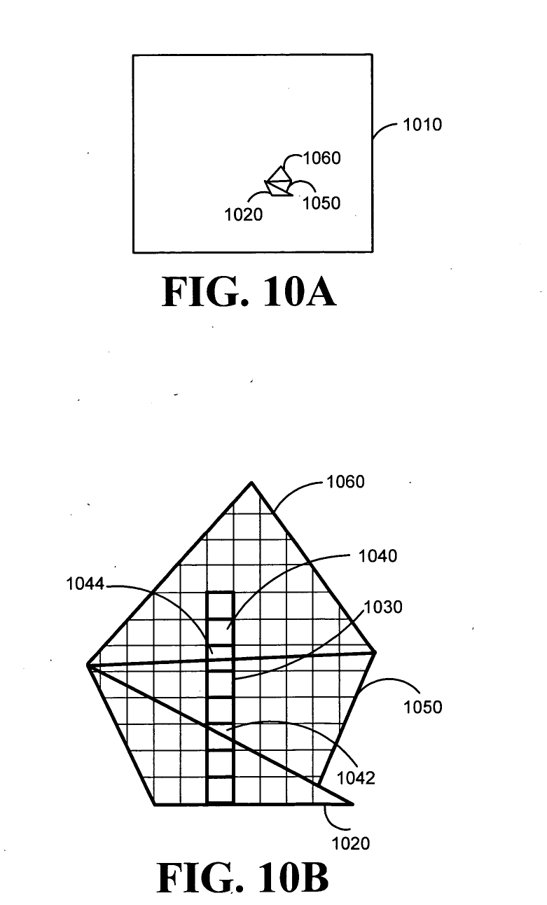

Reference is now made to FIGS. 10A and 10B, which illustrate a partially covered tile having two partially covered pixels as utilized in embodiments of the present disclosure. It should be appreciated that the illustration of FIGS. 10A and 10B are significantly simplified to facilitate the illustration of certain aspects of embodiments of the disclosure. However, the simplified illustration provided herein is sufficient for persons skilled in the art to implement more complex and realistic examples.

Referring first to FIG. 10A, adjacent triangle primitives 1020, 1050 and 1060 are shown within the boundaries of a display 1010. As is well known, a computer graphics display will often render hundreds or thousands of primitives, which are frequently broken down to triangle primitives, such as triangles 1020, 1050 and 1060. As discussed in reference to FIG. 8, span and tiled generation components will break a primitive up into pixels 1040 (FIG. 10B) as defined by vertical lines crossing scan lines. Pixels 1040 are often grouped into tiles of 2×2, 4×4, 8×8, or other sized dimensions. FIG. 10B illustrates a tile 1030 having a dimension of 1×8 pixels. The alignment of tile 1030 is arbitrarily illustrated with reference to the triangle primitives 1020, 1050 and 1060. Unlike the case of a fully covered tile as illustrated in FIG. 8 and the tile having only one partially covered pixel edge as shown in FIG. 9, the tile 1030, as shown in FIG. 10B is partially covered by the primitives 1020, 1050 and 1060 and contains two partially covered pixels, 1042 and 1044. Since the tile 1030 has two partially covered pixels, 1042 and 1044, optimized color compression will require reading the color data of all sub-pixels in the partially covered pixels 1042 and 1044. Although the savings in memory is less than realized in the previously discussed examples, the savings in memory traffic still justifies performing the color compression, especially as the sampling rate increases.

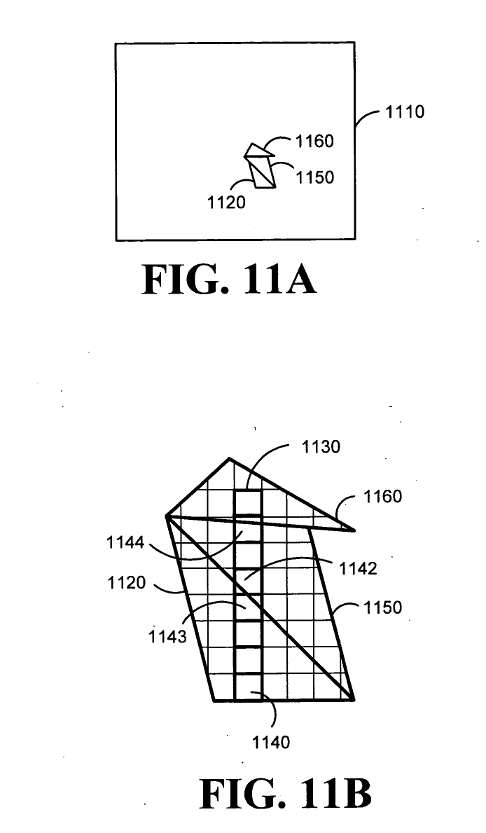

Reference is now made to FIGS. 11A and 11B, which illustrate a tile, partially covered by three primitives, that may be utilized in embodiments of the present disclosure. It should be appreciated that the illustration of FIGS. 11A and 11B are significantly simplified to facilitate the illustration of certain aspects of embodiments of the disclosure. However, the simplified illustration provided herein is sufficient for persons skilled in the art to implement more complex and realistic examples.

Referring first to FIG. 11A, adjacent triangle primitives 1120, 1150 and 1160 are shown within the boundaries of a display 1110. As is well known, a computer graphics display will often render hundreds or thousands of primitives, which are frequently broken down to triangle primitives, such as triangles 1120, 1150 and 1160. As discussed in reference to FIG. 8, span and tiled generation components will break a primitive up into pixels 1140 (FIG. 11B) as defined by vertical lines crossing scan lines. Pixels 1140 are often grouped into tiles of 2×2, 4×4, 8×8, or other sized dimensions. FIG. 11B illustrates a tile 1130 having a dimension of 1×8 pixels. The alignment of tile 1130 is arbitrarily illustrated with reference to the triangle primitives 1120, 1150 and 1160. Unlike the previous examples having no more than two partially covered pixels, the tile 1130, as shown in FIG. 11B is partially covered by the primitives 1120, 1150 and 1160 and contains three partially covered pixels 1142, 1143, and 1144. Since the tile 1130 has three partially covered pixels, 1142, 1143, and 1144, an eight-bit exemplary compression code, as discussed below in reference to FIG. 13, may be unable to accommodate the data necessary to support compression of the tile color data. One of ordinary skill in the art will appreciate that a compression code configured as more or less than eight-bits is contemplated within this disclosure and, moreover, that the optimal compression code size will vary based on a variety of system and architecture parameters. In this exemplary case, optimization suggests treating the color data for the tile as uncompressible and reading all of the tile color data from the frame buffer.

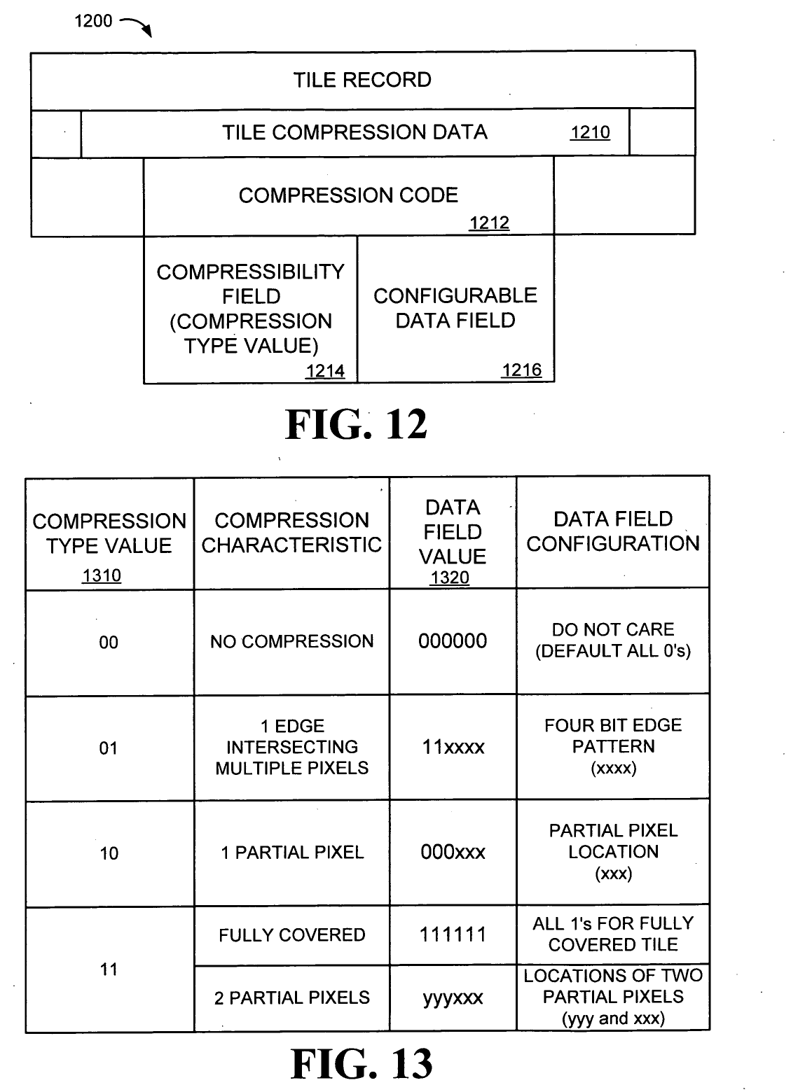

Reference is now made to FIG. 12, which is a block diagram illustrating an exemplary tile record format of an embodiment. The tile record 1200 is stored in external memory and includes tile compression data 1210. The tile compression data 1210 includes a compression code 1212 for indicating if the tile is compressible and providing compression related data generated from an edge data bitmask. The edge data bitmask is a mask that identifies the pixel location of all primitive edges. The compression code 1212 is generated from the edge data bitmask that corresponds to each tile. The compression code 1212 includes a compressibility field 1214, which contains a compression type value. The compression code 1212 also includes a configurable data field 1216 for accommodating tile specific related data.

Reference is now made to FIG. 13, which is a table illustrating an exemplary configuration for an eight-bit compression code, as disclosed herein. As discussed above regarding FIG. 12, a compressibility field 1214 includes a compression type value 13 10, which, in some embodiments, utilizes two of eight total bits in the compression code 1212. Also, the configurable data field 1216, as discussed regarding FIG. 12, includes a data field value 1320, which corresponds to different data types, depending on the compression type value 1310. As shown in the first row, a compression type value of “00” indicates that compression of the color data for that tile is unavailable using the compression code 1212. In this circumstance, as is shown, the data field value is not used and has, for example, a default value of “000000”.

Referring to the last row of the table, a compression type value 1310 of “11” combined with a data field value 1320 of “11111” indicates that all pixels in the tile are fully covered by the same primitive and, as previously discussed in reference to FIGS. 8A-8D, represents the best available compression. Where the compression type value 1310 is “11” and the data field value 1320 includes any “0”, the data field value 1320 “yyyxxx” contains the location values of two partially covered pixels in locations “yyy” and “xxx” within the tile. This case is consistent with the example previously discussed in reference to FIGS. 10A and 10B. Although this compression does not result in the memory savings realized for a fully covered tile, the savings still justifies performing the color compression, especially as the sampling rate increases.

Referring to the third row of the table, a compression type value 1310 of “10” represents the case where the tile contains one partially covered pixel, as previously discussed in reference to FIGS. 9A and 9B. In this case, the data field value 1320 is “000xxx” where the “xxx” is the location value of the partially covered pixel within the tile. The “000” portion of the data field value represents unutilized data for this particular case and may be set at “000” for a default value.

Reference is now made to the second row of the table, where the compression type value 1310 of “01” indicates that one edge intersects multiple pixels within the tile. In this case, the data field value 1320 is “11xxxx”, where the “xxxx” is an edge pattern number and the “11” is an unutilized portion of the compression code. The edge pattern number is used to obtain an edge function from a lookup table. The edge function will be used to determine where each sub-pixel is located relative to the edge in each of the partially covered pixels. Since the sub-pixels within the tile are located on different sides of the edge, the color data for the sub-pixels of the partially covered pixels will have to be stored.

In some implementations an optimization of the color compression will support the compression of color data for a tile covered by more than two primitives. For example, in a system having higher sampling rate, the cost of the optimization, although high, may still be justified due to a savings in memory traffic. Similarly, one of ordinary skill in the art knows or will know that a compression code of more than eight bits may be required to support color compression of different tile sizes or more than two partially covered pixels.

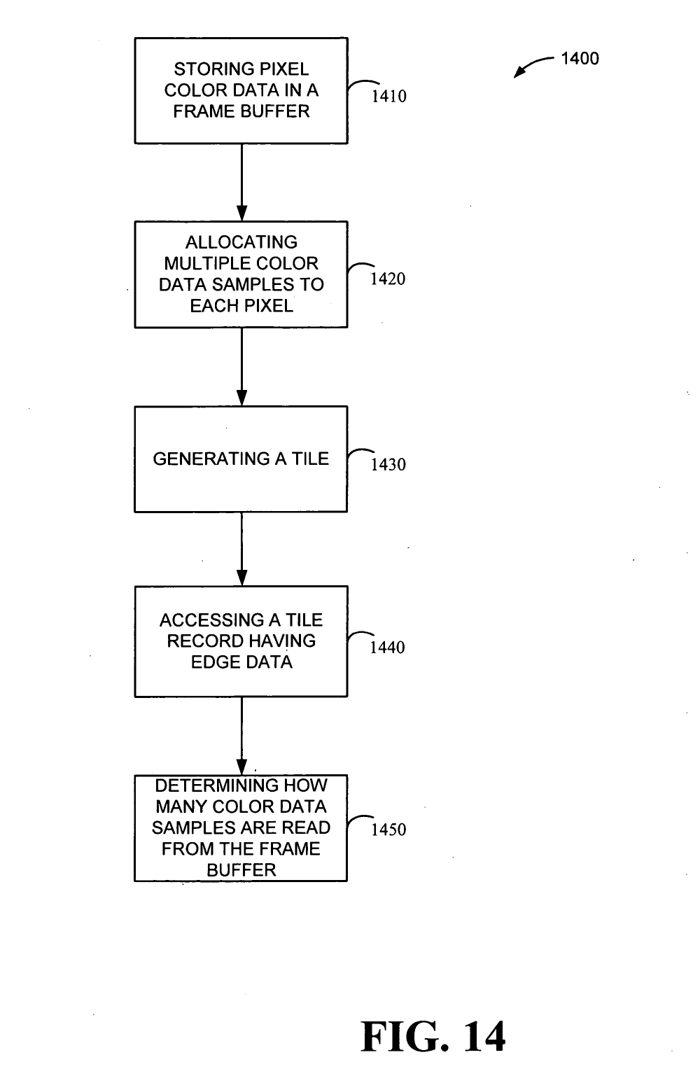

Reference is now made to FIG. 14, which is a block diagram illustrating a method of compressing color data in an embodiment disclosed herein. The method 1400 stores pixel color data in the frame buffer for possible reading by the GPU in block 1410. Multiple color samples are allocated to each pixel 1420. The number of color data samples per pixel is determined based on, for example, the system capacity and the graphics resolution requirements. This figure is referred to as the sampling rate in an MSAA scheme. Tiles are generated by allocating multiple pixels per tile 1430. The tiles are groups of pixels having specific dimensional configurations such as 2×2, 4×4, 8×8, or, as in the above examples, 1×8 pixels.

A tile record is accessed from memory external to the GPU in block 1440.

The tile record includes compression data generated from the content of an edge location bitmask. Reading the separate tile record including the tile compression data requires very little read traffic compared to the resulting decrease in traffic corresponding to the compression of the color data using the edge location bitmask to identify which pixels contain edges. Based on the compression data, some portion of the color data samples are determined to be required from the frame buffer 1450. To the extent the reading and storage of color data is unnecessary due to the color compression methods herein, system memory traffic is reduced.

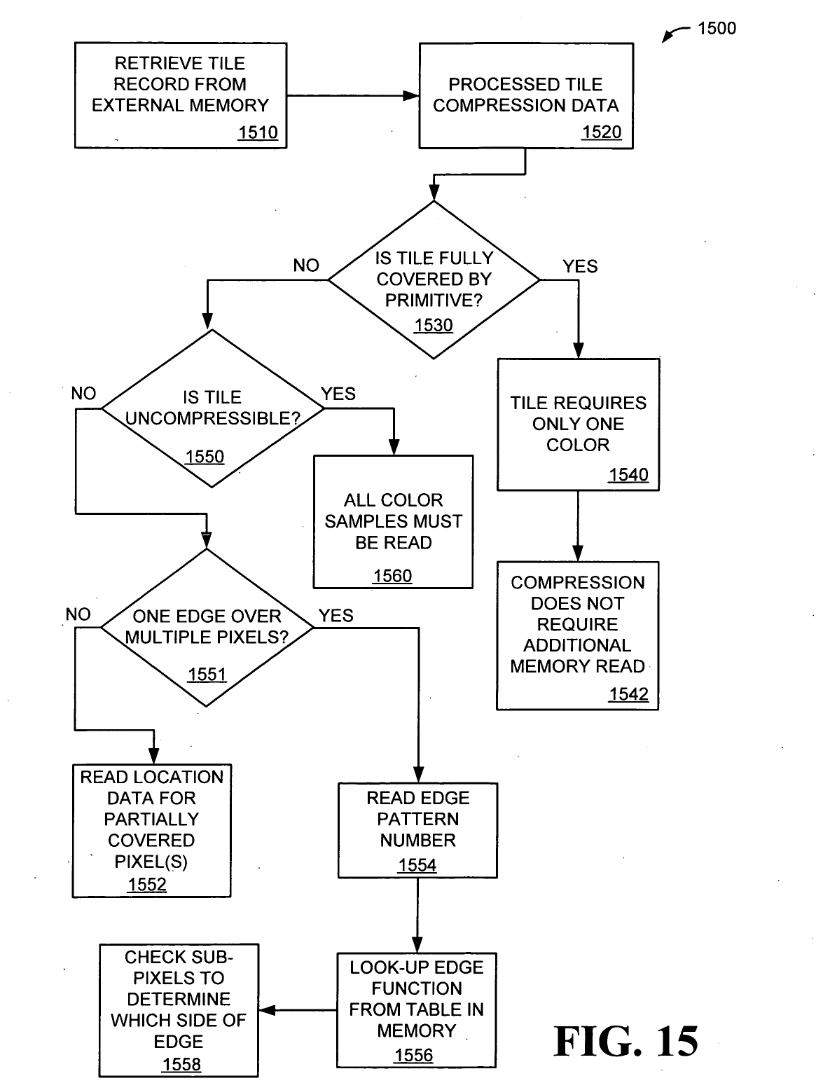

Reference is now made to FIG. 15, which is a block diagram illustrating a method of compressing color data in an embodiment disclosed herein. Under the method 1500, the tile record is retrieved from external memory 1510. As discussed above, the traffic from reading the tile record is insignificant compared to the reduction in memory traffic corresponding to the memory traffic savings realized from the compression of the color data. Within the tile record, the tile compression data is processed in block 1520. The tile compression data indicates, in part, whether the tile is fully covered by a primitive 1530. If the tile is fully covered by a primitive then the tile only requires one color 1540, wherein the color data is represented by one of the multiple color data samples in an MSAA system. In this circumstance, the compression does not require an additional memory read 1542 and a large quantity of memory traffic is saved.

In the alternative to the fully covered tile, the tile compression data indicates whether the tile is uncompressible 1550. If the tile is uncompressible, then all color samples must be read per step 1560. If the tile is compressible, the tile compression data indicates whether the tile has one edge covering multiple pixels 1551 within the tile. If this is the case, then the edge pattern number is read in block 1554, the corresponding edge function is looked up in a table based on the edge pattern number 1556, and sub-pixels in partially covered pixels are checked to determine which side of the edge they are on 1558. Alternatively, the tile has one or two partially covered pixels and the location data for the partially covered pixels is read in block 1552. The location data is used to determine which of the color samples must be read from the frame buffer. One of ordinary skill in the art knows or will know that alternative embodiments under this disclosure support the compression of color data in tiles having more than two partially covered pixels, more than one edge, or a combination of both if the bit width of the compression code is made large.

The embodiments of the present disclosure can be implemented in hardware, software, firmware, or a combination thereof. In some embodiments, the compression of color data is implemented in software or firmware that is stored in a memory and that is executed by a suitable instruction execution system. If implemented in hardware, as in an alternative embodiment, the compression of color data can be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the embodiments of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, including any embodiments described, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A system for compressing color data in a computer graphics system, comprising:
a graphics processing unit (GPU);
a frame buffer, in communication with the GPU, adapted to maintain color data for a pixel;
a plurality of sub-pixels, such that each of the plurality of sub-pixels comprises a color sample for the pixel;
a sampling rate, wherein the sampling rate comprises the number of sub-pixels per pixel and wherein the sampling rate is predetermined;
a tile, wherein the tile comprises a plurality of pixels; and
a tile record, wherein the tile record comprises tile compression data.

2. The system of claim 1, wherein the tile compression data comprises edge location data, such that an edge defines a boundary between a plurality of primitives.

3. The system of claim 2, wherein the edge location data comprises data that indicates if all pixels in the tile are covered by one of the plurality of primitives.

4. The system of claim 3, wherein color data for a fully covered tile comprises color data for one sub-pixel.

5. The system of claim 2, wherein the edge location data comprises partially covered pixel location data.

6. The system of claim 5, wherein the partially covered pixel location data comprises an edge pattern number.

7. The system of claim 6, further comprising an edge function lookup table, wherein an edge function can be accessed using the edge pattern number.

8. The system of claim 7, wherein the plurality of sub-pixels in a partially covered pixel are analyzed using the edge function to determine where each of the plurality of sub-pixels is located relative to the edge.

9. The system of claim 5, wherein the partially covered pixel location data comprises data defining the location of a first partially covered pixel in the tile.

10. The system of claim 9, wherein the partially covered pixel location data further comprises data defining the location of a second partially covered pixel in the tile.

11. The system of claim 2, wherein the edge location data comprises incompressible tile data, for indicating that the color data for the tile is incompressible.

12. A method of compressing color data in a computer graphics system, comprising the steps of:
storing pixel color data in a frame buffer;
allocating a plurality of color data samples to each pixel, wherein each of the plurality of color data samples comprises a sub-pixel, such that each pixel comprises a plurality of sub-pixels;
generating a tile, such that the tile comprises a plurality of pixels;
accessing a tile record, such that the tile record comprises edge data indicating whether the tile is covered by an edge, such that an edge is a boundary between primitives; and
determining, using the edge data, how many of the plurality of color data samples is read from the frame buffer.

13. The method of claim 12, wherein if the edge data indicates that the tile is not covered by an edge, then the pixel color data for all pixels in the tile comprises one of the plurality of color data samples.

14. The method of claim 13, wherein the edge data comprises a compression code.

15. The method of claim 14, wherein the compression code comprises a compressibility field, containing a compression type value, for indicating the compressibility of the color data.

16. The method of claim 15, the compression code further comprising a configurable data field, for providing specific data in conjunction with the compression type value.

17. The method of claim 15, wherein the compression type value indicates that location data for a first partially covered pixel is contained in the configurable data field.

18. The method of claim 17, wherein the compression type value indicates that location data for a second partially covered pixel is contained in the configurable data field.

19. The method of claim 16, wherein the compression type value indicates that an edge pattern number is contained in the configurable data field, for determining an edge function in a look-up table.

20. The method of claim 19, further comprising the step of testing the plurality of sub-pixels to determine the location of each of the plurality of sub-pixels relative to the edge.

21. The method of claim 14, wherein the compression code indicates that all of the pixels in the tile are fully covered, such that the color data for the tile is read as one sub-pixel.

22. The method of claim 14, wherein the compression code indicates that the color data for the tile is uncompressible, such that data for all of the plurality of color data samples is read from the frame buffer.

23. Computer graphics hardware, comprising a means for generating a compression code for color data using an edge data bitmask containing location data for primitive edges relative to sub-pixel locations.

24. A computer graphics system comprising:
multi-sample anti-aliasing logic configured to store a plurality of color samples for each pixel, wherein each color sample comprises a sub-pixel, such that the color data for each pixel comprises a plurality of sub-pixels, and wherein a tile comprises a plurality of pixels; and
color data compression logic configured to provide a compression code for each tile, wherein the compression code comprises a compressibility value field and a configurable data field, such that the type of data in the configurable data field depends on the compressibility value field.

25. The computer graphics system of claim 24, wherein the compression code further comprises data generated from an edge data bitmask, such that the edge data bitmask contains location of edges relative to pixels.

26. The computer graphics system of claim 24, wherein the compression code further comprises a compression type value stored in the compressibility value field.

27. The computer graphics system of claim 24, wherein the configurable data field comprises location data for a first partially covered pixel and a second partially covered pixel.

28. The computer graphics system of claim 24, wherein the configurable data field comprises an edge pattern number, such that an edge pattern is determined from a lookup table.

29. A system for compressing color data in a computer graphics system, comprising:
a computer graphics display;
a plurality of pixels for rendering an image in the computer graphics display;
a plurality of sub-pixels within each of the plurality of pixels, wherein each of the plurality of sub-pixels stores color sample data; and
a compression code, for color data, wherein a bitmask containing edge location data is utilized to generate the compression code for a tile of a plurality of pixels.
